(19) United States
(12) Patent Application Publication
(10) Pub. No.: US 2024/0239198 A1
(43) Pub. Date: Jul. 18, 2024

(54) HIGH VOLTAGE VEHICLE ARCHITECTURE

(71) Applicant: Ford Global Technologies, LLC, Dearborn, MI (US)

(72) Inventors: John Penney, Livonia, MI (US); Charles Moore, Madison Heights, MI (US); Senate Ghanim, Dearborn, MI (US); Brett Babin, Detroit, MI (US)

(21) Appl. No.: 18/153,812

(22) Filed: Jan. 12, 2023

(51) Int. Cl. B60L 1/00; B60L 58/20

(52) U.S. Cl. CPC B60L 1/003; B60L 58/20

(57) ABSTRACT

Methods and systems are provided for an electrical architecture of an electrified vehicle. In one example, the electrified vehicle may have at least one electric transaxle with a power distribution device and a battery supplying power to the power distribution device. The electrified vehicle may further include an electrical interfacing device electrically coupled to the power distribution device and positioned proximate to the at least one electric transaxle, the electrical interfacing device configured to deliver power to electrical consumers external to the electrified vehicle.

### FIELD

The present description relates generally to methods and systems for electrical power management for a vehicle.

### BACKGROUND/SUMMARY

For an electrified vehicle, including hybrid electric vehicles (HEVs) and battery electric vehicles (BEVs), electrical energy provided by an energy storage device may be used to enable vehicle propulsion and power auxiliary devices electrically coupled to the vehicle. In one example, power from the energy storage device may be transmitted to a power takeoff or auxiliary load, through an electrical interfacing device, such as an onboard generator inverter (OBGi). The OBGi may deliver power from the energy storage device to one or more devices external to the vehicle via electrical circuity to output a target voltage and current. As such, the OBGi may be electrically coupled to the energy storage device using high voltage cables and connectors.

In addition to the energy storage device and the OBGi, an electric power system of the electrified vehicle may be complex and include various devices, cables, and connectors. In particular, numerous modules may be connected to a high voltage (HV) bus coupled to the energy storage device of the electric power system, resulting in a high demand for available ports at the HV bus. Incorporating more electrical devices into the electric power system may be challenging due to constraints on available ports, space, and routing of electrical wiring in an already tightly packaged region of the vehicle.

In one example, the issues described above may be at least partially addressed by electrified vehicle including at least one electric transaxle having a power distribution device, and a battery supplying power to the power distribution device. The electrified vehicle may further include an electrical interfacing device electrically coupled to the power distribution device and positioned proximate to the at least one electric transaxle, the electrical interfacing device configured to deliver power to electrical consumers external to the electrified vehicle. In this way, power may be delivered from the battery to the electrical interfacing device without demanding cumbersome routing of cables and with a flexible reconfigurable electrical architecture.

As one example, the battery and the electrical interfacing device may be electrically coupled to the electric transaxle by a splitter header. One portion of the splitter header may be connected to the electric transaxle and another portion of the splitter heater may be coupled to each of the battery and the electrical interfacing device. Power transmission between the battery, electrical interfacing device, and the electric transaxle is thereby enabled. By coupling the electric interfacing device to the electric transaxle, battery power for energizing external electrical consumers may be more readily accessible without relying on excessively long cables. The electrified vehicle may thereby operate efficiently as a power station, in addition to a means of transportation.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example of an electrified vehicle layout.

FIG. 2 shows an example of an onboard generator inverter (OBGi) system which may be included in the electrified vehicle layout of FIG. 1.

FIG. 3 shows an example of an optimized electrical architecture for an electrified vehicle, including a bi-directional splitter coupled to a power distribution unit (PDU) of the electrified vehicle.

FIG. 4 shows an example of the bi-directional splitter.

FIG. 5 shows the bi-directional splitter coupled to a conventional high-voltage electrical distribution system (HVEDS) connector.

FIG. 6 shows a first example of an electrical configuration of the bi-directional splitter.

FIG. 7 shows a second example of an electrical configuration of the bi-directional splitter.

FIG. 8 shows a first use-case example for the bi-directional splitter.

FIG. 9 shows a second use-case example for the bi-directional splitter.

FIG. 10 shows a third use-case example for the bi-directional splitter.

FIG. 11 shows a fourth use-case examples for the bi-directional splitter.

FIG. 12 shows an example of a method for distributing power using the bi-directional splitter.

### DETAILED DESCRIPTION

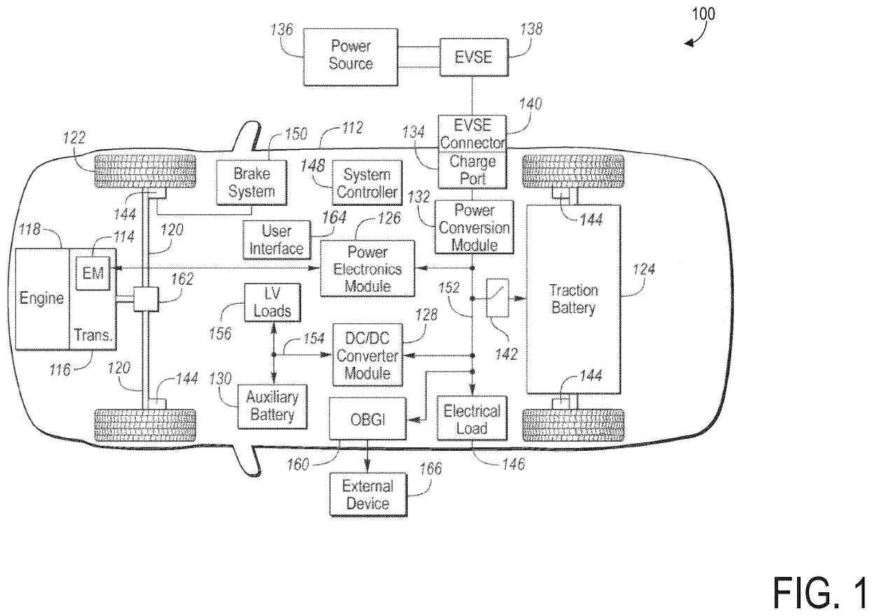

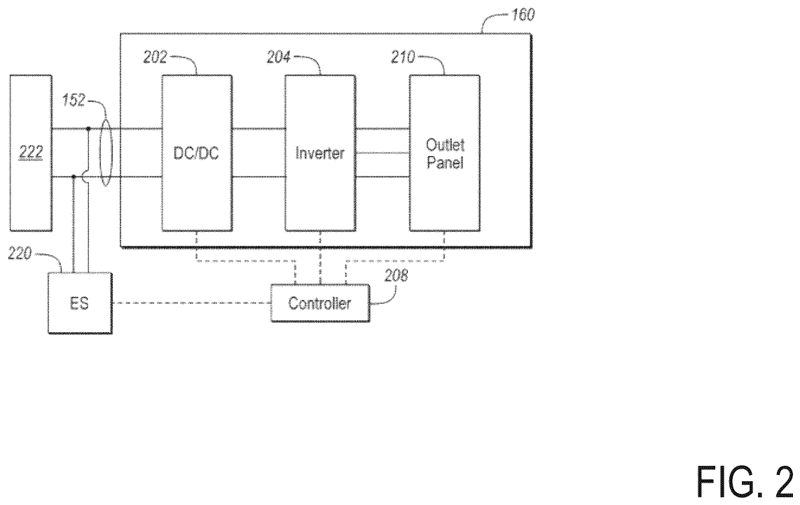

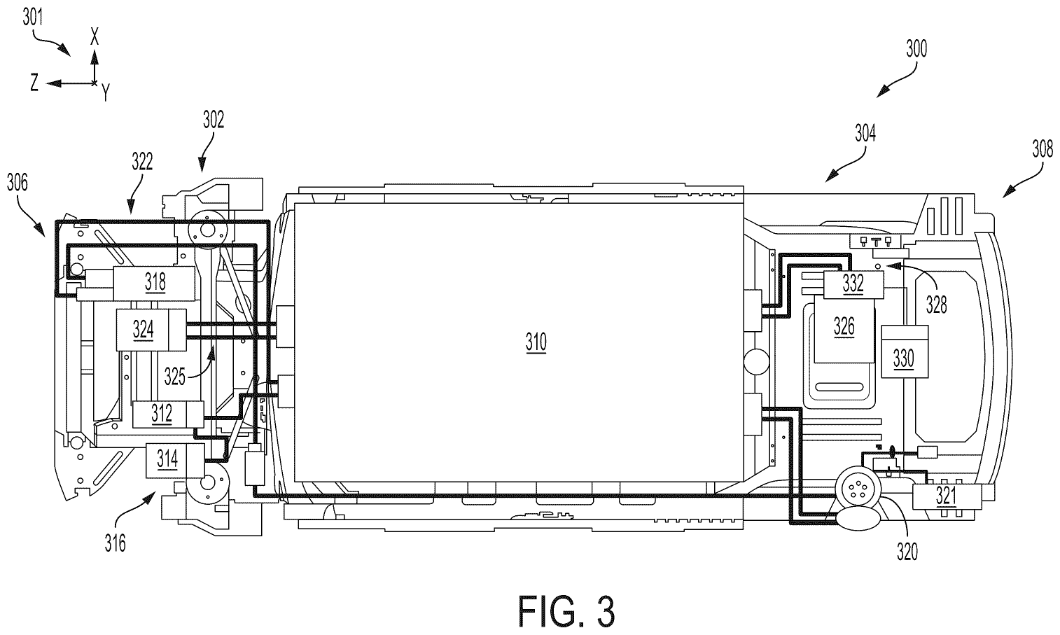

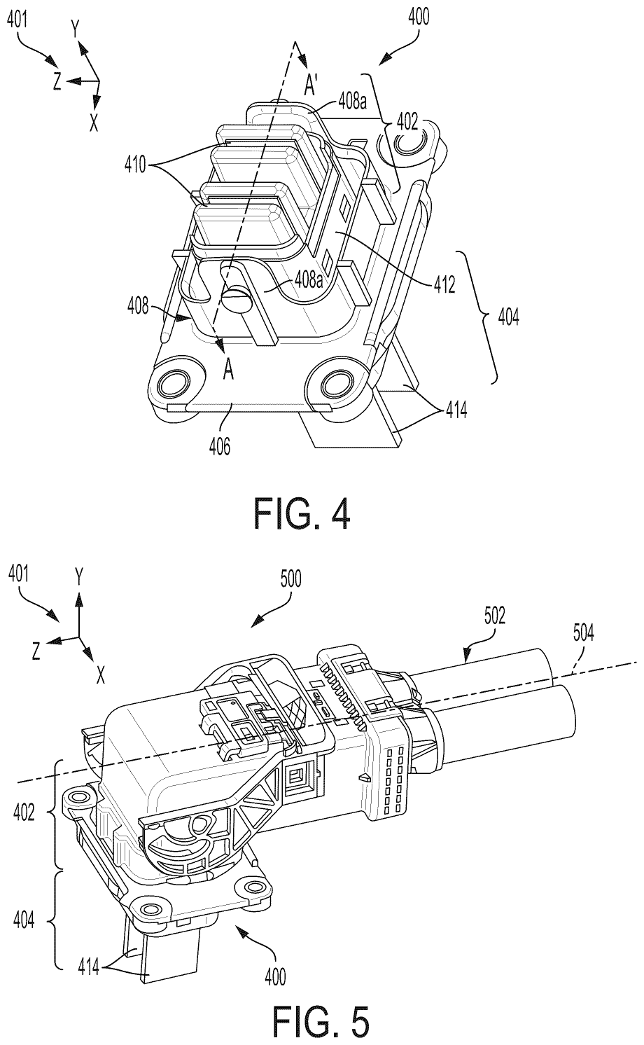

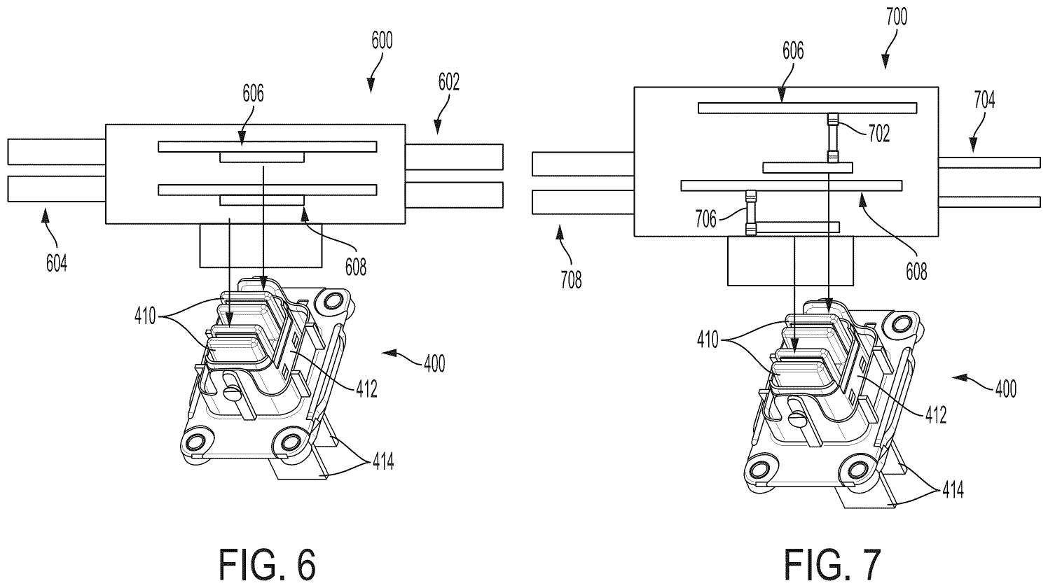

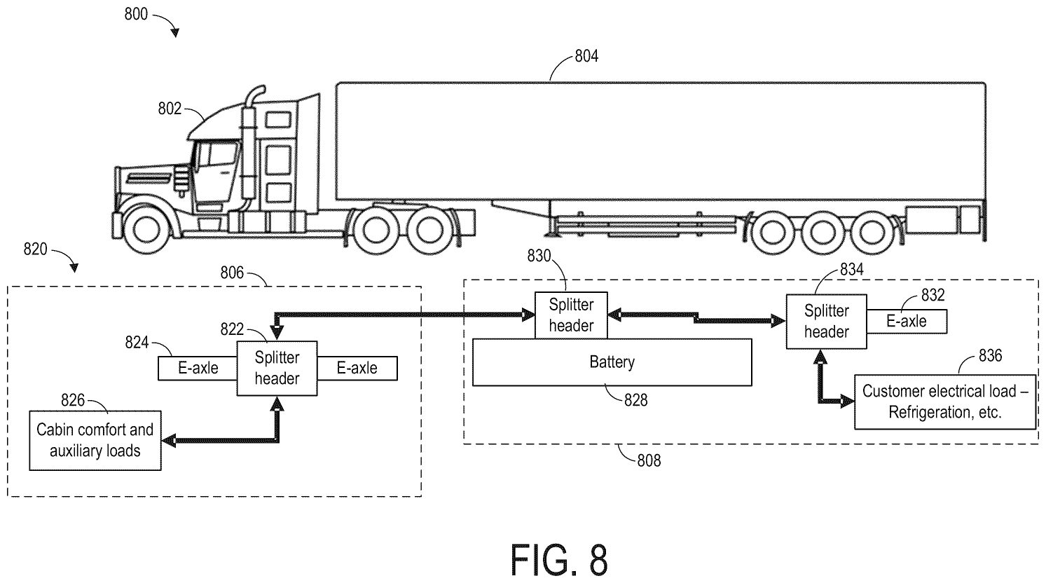

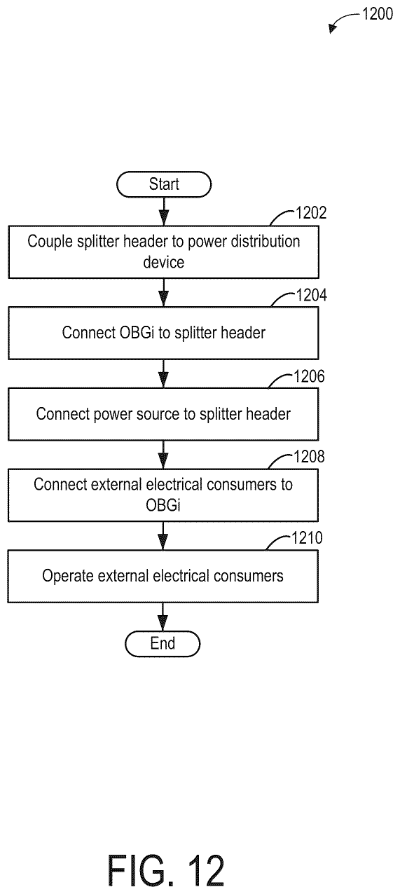

The following description relates to systems and methods for electrical power management for a vehicle. The vehicle may be an electrified vehicle having at least one electric transaxle and high-voltage battery. Power may be distributed amongst various components of the vehicle, as shown in FIG. 1, including an onboard generator inverter (OBGi). The OBGi, as depicted in FIG. 2, may be used to deliver power from the battery of the vehicle to electrical consumers arranged external to the vehicle, where reference to being external of the vehicle may be defined as having an electrical circuit that is independent and separate from electrical circuits of the vehicle corresponding to vehicle operation. In order to increase accessibility of the OBGi and to circumvent routing of excessively long cables, the OBGi may be electrically coupled to a power distribution device of the electric transaxle, as illustrated in FIG. 3. Coupling of the OBGi to the power distribution device may be enabled by a bi-directional splitter header. An example of the splitter header is shown in FIG. 4 and depicted coupled to a high-voltage electrical distribution system (HVEDS) connector in FIG. 5. Examples of an electrical connectivity of the splitter header to electrical circuits of the vehicle are shown in FIGS. 6 and 7. The bi-directional splitter header, in addition to enabling power to be delivered to the OBGi from the battery, may also allow additional electrical devices to be electrically coupled to the battery while transmitting power to the OBGi. As such, the splitter header may enable various power distribution configurations for an electrified vehicle, as illustrated in FIGS. 8-11. An example of a method for utilizing the splitter header in an electrical architecture of a vehicle is shown in FIG. 12.

Turning now to FIG. 1, an electrical power layout 100 of an electrified vehicle 112 is depicted, which, in one example, may be a plug-in hybrid-electric vehicle (PHEV). In another example, however, the electrified vehicle 112 may be a battery electric vehicle (BEV) in which an engine 118 shown in FIG. 1 may not be present. In other examples, the electrified vehicle 112 may be a full hybrid-electric vehicle (FHEV) without plug-in capability. It will be appreciated that the electrical power layout is depicted as a generalized diagram providing an overview of power transmission in the electrified vehicle 112 and relative positions of components shown and described in FIG. 1 are non-limiting examples of how the components may be arranged within the electrified vehicle 112. However, components depicted outside of an outline of the electrified vehicle corresponds to positioning of the respective components electrically and/or physically external to the electrified vehicle 112.

The electrified vehicle 112 may include one or more electric machines 114 mechanically coupled to a gearbox or hybrid transmission 116. The electric machines 114 may operate as a motor and a generator. In addition, the hybrid transmission 116 is mechanically coupled to the engine 118. The hybrid transmission 116 may be mechanically coupled to a differential 162 that is configured to adjust a speed of drive shafts 120, also referred to as a drive axle, which may be mechanically coupled to drive wheels 122 of the vehicle 112. In some examples, a clutch may be disposed between the hybrid transmission 116 and the differential 162.

The electric machines 114 may provide propulsion and speed control capabilities when the engine 118 is turned on or off. The electric machines 114 may also act as generators, thereby providing fuel economy benefits by recovering energy that may otherwise be lost as heat in a friction braking system. The electric machines 114 may also reduce vehicle emissions by allowing the engine 118 to operate at more efficient speeds and enabling the electrified vehicle 112 to be operated in an electric mode with the engine 118 off under certain conditions.

A battery pack or traction battery 124 may store energy that can be used by the electric machines 114 and may output a high voltage direct current (DC). A contactor module 142 may include one or more contactors configured to isolate the traction battery 124 from a high-voltage bus 152 when opened and connect the traction battery 124 to the high-voltage bus 152 when closed. In some examples, the contactor module 142 may be integrated with the traction battery 124.

The high-voltage bus 152 may include power and return conductors for carrying current over the high-voltage bus 152. One or more power electronics modules 126 may be electrically coupled to the high-voltage bus 152. The power electronics modules 126 may also be electrically coupled to the electric machines 114 and may enable bi-directional transfer energy between the traction battery 124 and the electric machines 114. For example, a traction battery 124 may provide a DC voltage while the electric machines 114 may operate with a three-phase alternating current (AC) to function. The power electronics module 126 may convert the DC voltage to a three-phase AC current to operate the electric machines 114. In a regenerative mode, the power electronics module 126 may convert the three-phase AC current from the electric machines 114 acting as generators to the DC voltage compatible with the traction battery 124.

In addition to providing energy for propulsion, the traction battery 124 may provide energy for other vehicle electrical systems. To deliver power to the electrical systems, the vehicle 112 may include a DC/DC converter module 128 that converts the high voltage DC output from the high-voltage bus 152 to a low-voltage DC level of a low-voltage bus 154 that is compatible with low-voltage loads 156. An output of the DC/DC converter module 128 may be electrically coupled to an auxiliary battery 130 (e.g., 12V battery) to allow the auxiliary battery 130 to be charged. The low-voltage loads 156 may be electrically coupled to the auxiliary battery 130 via the low-voltage bus 154 while one or more high-voltage electrical loads 146 may be coupled to the high-voltage bus 152. The high-voltage electrical loads 146 may have an associated controller that operates and controls the high-voltage electrical loads 146 when appropriate. Examples of high-voltage electrical loads 146 may include a fan, an electric heating element and/or an air-conditioning compressor.

The electrified vehicle 112 may be configured to recharge the traction battery 124 from an external power source 136. The external power source 136 may be a connection to an electrical outlet, for example, which may be included in an electrical power distribution network or grid as provided by an electric utility company and may be electrically coupled to a charge station or electric vehicle supply equipment (EVSE) 138. The EVSE 138 may provide circuitry and controls to regulate and manage the transfer of energy between the power source 136 and the vehicle 112 by receiving DC or AC electric power from the external power source 136. A charge connector 140 may be used to couple the EVSE 138 to a charge port 134 of the vehicle 112. The charge port 134 may be any type of port configured to transfer power from the EVSE 138 to the electrified vehicle 112.

The charge port 134 may be electrically coupled to an on-board power conversion module or charger 132. The charger 132 may condition the power supplied from the EVSE 138 to provide suitable voltage and current levels to the traction battery 124 and the high-voltage bus 152. As such, the charger 132 may interface with the EVSE 138 to coordinate the delivery of power to the vehicle 112. The EVSE connector 140 may have pins that mate with corresponding recesses of the charge port 134. Alternatively, various components described as being electrically coupled or connected may transfer power using a wireless inductive coupling.

The electrified vehicle 112 may include one or more wheel brakes 144 for controlling vehicle speed and inhibiting vehicle motion. The wheel brakes 144 may be hydraulically actuated, electrically actuated, or some combination thereof and may be included in a brake system 150. The brake system 150 may include other components for operating the wheel brakes 144. For simplicity, a single connection between the brake system 150 and one of the wheel brakes 144 is show in FIG. 1 but connections between the brake system 150 and the other wheel brakes 144 may also be present. The brake system 150 may include a controller to monitor and coordinate the brake system 150 which, in turn, may monitor the brake components and control the wheel brakes 144 for vehicle speed control. The brake system 150 may respond to driver commands and may also operate autonomously to implement features such as stability control. The controller of the brake system 150 may implement a method of applying a requested brake force when requested by another controller or sub-function.

Electronic modules in the electrified vehicle 112 may communicate via one or more vehicle networks (not shown in FIG. 1). The vehicle network may include a plurality of channels for communication. One channel of the vehicle network may be a serial bus such as a Controller Area Network (CAN). Additional channels of the vehicle network may include discrete connections between modules and may include power signals from the auxiliary battery 130. Different signals may be transferred over different channels of the vehicle network. For example, video signals may be transferred over a high-speed channel (e.g., Ethernet) while control signals may be transferred over CAN or discrete signals. The vehicle network may include any hardware and software components that aid in transferring signals and data between modules and may connect to any electronic module that is present in the electrified vehicle 112. A vehicle system controller (VSC) 148 may be present to coordinate the operation of the various components. Note that operations and procedures that are described herein may be implemented in one or more controllers. Implementation of features that may be described as being implemented by a particular controller is not necessarily limited to implementation by that particular controller. Operations may be distributed among multiple controllers communicating via the vehicle network.

The electrified vehicle 112 may also include a user interface 164 for interfacing with the operator. The user interface 164 may include display elements, such as lamps, a liquid-crystal display (LCD) module, and a touch screen. The user interface 164 may further include input devices, such as switches, buttons, or touch-screen inputs.

The electrified vehicle 112 may be configured to provide electrical power for external devices. The electrified vehicle 112 may further include an on-board generator inverter (OBGi) system 160. The OBGi system 160 may be a vehicle system configured to provide electrical power to one or more external devices 166. The OBGI system 160 may receive power from the high-voltage bus 152 and the traction battery 124 and may include power conversion circuitry to generate an output voltage and current for the external devices 166 connected to the OBGi system 160.

An example of a configuration of the OBGi system 160 is illustrated in FIG. 2. The OBGi system 160 may include a DC/DC power converter 202 that provides power to an inverter 204. In some examples, operation of the DC/DC power converter 202 may be enabled by the DC/DC converter module 128 of FIG. 1 that powers the low-voltage bus 154. The inverter 204 may be configured to convert a DC voltage input to an alternating current (AC) voltage output and the DC/DC power converter 202 may be configured to adjust the voltage level of the traction battery 124 of FIG. 1 to a voltage level used by the inverter 204. The inverter 204 may be configured to provide one or more voltage outputs. For example, the inverter 204 may be configured to provide three voltage outputs (e.g., a three-phase inverter). In some instances, the OBGi system 160 may be configured to utilize existing DC/DC converters and inverters that are in the electrified vehicle 112 of FIG. 1 (e.g., the DC/DC converter module 128 and the power electronics module 126). The electrified vehicle may include a controller 208 configured to operate the components of the OBGi system 160, including the DC/DC converter 202 and the inverter 204, and may be included in the OBGi system 160, as an example.

Power sources 222 may include the traction battery 124 and the electric machines 114 operating as generators driven by the engine 118 of FIG. 1 and may supply power to the high-voltage bus 152. The power sources 222 may further include any component configured to provide power to the high-voltage bus 152. Various electrical systems 220 may also be incorporated in the electrified vehicles, which may include electrical components that draw power from the high-voltage bus 152 (e.g., electric machines 114, DC/DC converter module 128, electrical loads 146, brake system 150).

While the OBGi system 160 draws power from the high-voltage bus 152, it may be considered as a separate electrical system from the electrical systems 220. For example, the controller 208 may be configured to operate the electrical systems 220 and/or affect operation of the electrical systems 220 independent of the OGBi system 160. The controller 208 may interact directly and/or indirectly with the electrical systems 220 to control an amount of power used by the electrical systems 220. As an example, the controller 208 may be in communication with the electrical systems 220 to set an amount of power that is available for the electrical systems 220. The controller 208 may operate in coordination with other controllers distributed in the vehicle to operate the electrical systems 220 which may include controlling an amount of power used by the electrical systems 220. Controlling the amount of power used may further include limiting power draw for one or more of the electrical systems 220 to an amount that is less than a demanded power usage.

The DC/DC power converter 202 may include inputs that are electrically coupled to the high-voltage bus 152 and the traction battery 124. The voltage level of the high-voltage bus 152 may be converted to a desired voltage input level for the inverter 204 by the DC/DC power converter 202. When operating in a bypass mode, the DC/DC power converter may transfer voltage of the high-voltage bus to the inputs of the inverter 204. The DC/DC power converter 202 may also be operated in boost modes which allows a voltage to be output that is greater than the voltage of the high-voltage bus 152, as well as buck modes of operation which allows a voltage to be output that is less than the voltage of the high-voltage bus 152. Furthermore, the DC/DC power converter 202 may include switching devices and circuit elements that are arranged and controlled to output the desired voltage level. The switching devices may be controlled by a controller (e.g., controller 208) that sequences the switching according to the desired power output.

The inverter 204 may be configured to provide one or more voltage/current outputs and convert a DC voltage input into one or more AC voltage outputs. In one example, the inverter 204 may be a three-phase inverter able to provide three AC voltage/current waveforms. The inverter 204 may include power switching circuitry that includes a plurality of switching devices such as Insulated Gate Bipolar Junction Transistors (IGBTs) or other solid-state switching devices. The switching devices may be arranged to selectively couple a positive terminal and a negative terminal of the high-voltage bus 152 to each terminal or leg of the inverter power output. Each of the switching devices within the power switching circuitry may have an associated diode connected in parallel to provide a path for inductive current when the switching device is in a non-conducting state. Each of the switching devices may also have a control terminal for controlling operation of the associated switching device. The control terminals may be electrically coupled to a controller. The controller may include associated circuitry to drive and monitor the control terminals. For example, the control terminals may be coupled to the gate input of the solid-state switching devices.

Each leg of the inverter 204 may include a first switching device that selectively couples the HV-bus positive terminal to the associated output terminal. A first diode may be coupled in parallel to the first switching device. A second switching device may selectively couple the HV-bus negative terminal to the associated output terminal. A second diode may be coupled in parallel to the second switching device. Each inverter output leg may be similarly configured. Each leg of the inverter 204 may be configured to control the voltage between the associated output terminal and a neutral terminal to a desired voltage magnitude and frequency.

The controller 208 may be programmed to operate the switching devices to control the voltage and current at the phase outputs. For example, the switching devices may be operated so that each inverter output is coupled to only one of the HV-bus positive terminal or the HV-bus negative terminal at a particular time. Various power output algorithms and strategies are available to be implemented in the controller 208 where the inverter outputs may be characterized by voltage magnitude, current magnitude, and frequency. The controller 208 may be programmed to operate the inverter 204 to achieve the desired voltage and current output waveform, e.g., by open-loop and/or closed loop strategies. The switching devices may be controlled by the controller 208 via a pulse-width modulated (PWM) gate signal.

The inverter 204 may include current sensors for each inverter power output. The current sensors may be, for example, inductive or Hall-effect devices configured to generate a signal indicative of the current passing through the associated circuit. The controller 208 may sample the current sensors at a predetermined sampling rate. Additionally, the inverter 204 may include one or more voltage sensors. The voltage sensors may be configured to measure an input voltage to the inverter 204 and/or one or more of the output voltages of the inverter 204. As an example, the voltage sensors may be resistive networks and include isolation elements to separate high-voltage levels from the low-voltage system. In addition, the inverter 204 may include associated circuitry for scaling and filtering the signals from the current sensors and the voltage sensors.

In some examples, as shown in FIGS. 1 and 3, the DC/DC power converter 202 and inverter 204 may be integrated as a single unit while maintaining operations as described above. As a result, the OBGI system 160 may provide one or more power outputs for external devices. The controller 208 may be configured to operate the DC/DC power converter 202 and the inverter 204 to achieve the desired inverter power outputs.

The OBGI system 160 may further include an outlet panel 210, thereby providing compatibility with Industrial and household systems. For example, household applications may utilize 120 VAC electrical power. Other household applications may use 240 VAC electrical power. The outlet panel 210 may be configured to support both types of power connections. The outlet panel 210 may be electrically coupled to the inverter 204 and may receive power therefrom.

As shown in FIG. 1, the electrical power layout of the electrified vehicle may include numerous components as well as electrical couplings between the components, e.g., cables, wires, connectors, etc. A footprint of the electrical power layout may therefore be large compared to available packaging space at the electrified vehicle. Although the OBGi is shown in FIG. 1 located along a side of the electrified vehicle, positioning of the OBGi proximate to a rear end of the vehicle may be desirable, in some examples. For example, when the electrified vehicle is a sport utility vehicle (SUV) or a truck, the electrified vehicle may be used to tow a trailer and/or to power mechanism such as a winch. Arranging the OBGi at the rear end of the vehicle may therefore preclude routing of long cables between the trailer and/or mechanisms and OBGi, when the OBGi is located proximate to the vehicle side. Furthermore, by positioning the OBGi at the rear rather than in a central region of the vehicle underbody, space constraints within the central region of the vehicle underbody may at least be partially alleviated. Relocating of the OBGi to the rear end of the vehicle, however, may demand lengthy and cumbersome cable routing to couple the OBGi to an HV battery of the vehicle. As an example, in electrified SUVs and trucks in which the battery may have a large footprint, the battery may be located in a central region of the vehicle underbody rather than at a rear axle, as shown in FIG. 1. In some examples, directly coupling the OBGi to the high-voltage bus of the battery may be challenging due to tight spacing of electrical components. A strategy for increasing accessibility of the OBGi while minimizing cable routing is therefore desirable.

In one example, the cable routing and space issues arising from positioning the OBGi at the rear end of the vehicle while maintaining electrical coupling of the OBGi to the battery may be at least partially addressed by leveraging power distribution provided by electric transaxles (e.g., e-axles) of the electrified vehicle. The e-axles may include electrical components such as an electric motor, an inverter, a reducer, etc., and may receive electrical power via a device for distributing power to the electrical components from the battery. Electrical consumers arranged external to the electrified vehicle but relying on energy from the battery for operation may receive battery power via the OBGi without direct coupling of the OBGi to the battery. Instead, the OBGi may be coupled to the power distribution device to receive battery power. For example, the power distribution device may be a power distribution unit (PDU) of an e-axle or a secondary drive unit (SDU) of an e-axle configured for all-wheel drive. The OBGi may thereby be positioned at a readily accessible and convenient region of the electrified vehicle, such as at the rear end of the vehicle. In instances where the electrified vehicle is a heavy duty vehicle configured to tow an accessory load, such as a trailer, the positioning of the OBGi at the rear of the electrified vehicle may allow electrical coupling to electrical consumers of the accessory load without relying on long electrical cables.

While a rear positioning of the OBGi may be most efficient for powering external loads trailing the electrified vehicle, by configuring the OBGi to be coupled to the power distribution device rather than directly to the high-voltage bus of the battery, the OBGi may be relocated to different regions of the electrified vehicle as desired. Coupling of the OBGi to the power distribution device may be enabled by a splitter header configured be connected to, e.g., plugged into, the power distribution device. The splitter header may further enable more than one electrical device to receive battery power via a single electrical junction. Details of the splitter header are provided further below, with reference to FIGS. 4-7.

An example of an electrical architecture for a vehicle 300 with e-axles is illustrated in FIG. 3, where the vehicle 300 may be an embodiment of the electrified vehicle 112 of FIG. 1. For example, the vehicle 300 may include the electrical power layout 100 of the electrified vehicle of FIG. 1 and additional electrical components specific to circuits for operation of the e-axles. Operation of electrical devices and components included in the electrical architecture may be controlled and monitored by a VSC, such as the VSC 148 of FIG. 1. For example, the VSC may oversee operation of the electrical devices by monitoring which devices and components are active or inactive, a status of the electrical devices and components, such as monitoring a battery state-of-charge, and adjusting operations of the electrical device and components accordingly. A set of reference axes 301 is provided, indicating an x-axis, a y-axis, and a z-axis. A length of the vehicle 300 is aligned parallel with the z-axis and the y-axis is parallel with a direction of gravity. A view of an underbody of the vehicle 300 is depicted in FIG. 3, and locations of a first e-axle 302 and a second e-axle 304 are indicated, where the first e-axle 302 is proximate to a front end 306 of the vehicle and the second e-axle is proximate to a rear end 308 of the vehicle 300.

The vehicle may be configured with a battery 310, which may be a high-voltage (HV) battery. The battery 310 may be electrically coupled to various electrical devices via a HV bus, for example. The electrical devices included in the electrical architecture of the vehicle 300 may include a positive temperature coefficient (PTC) heater 312 and an air conditioning (AC) compressor 314 of an HVAC circuit 316, as well as a DC/DC charger combo 318 coupled to a charge port 320 of a charging circuit 322, the charge port 320 similar to the charge port 134 of FIG. 1. A low-voltage (LV) inline interconnect 321 is coupled to the charge port 320 to send vehicle communication signals to other vehicle components. The electrical devices may further include a power distribution device for the first e-axle 302, such as a SDU 324 included in an all-wheel drive (AWD) circuit 325 of the electrical architecture. The SDU 324 may distribute power from the battery 310 to electrical components of the first e-axle 302 and may conversely, operate as a generator to charge the battery 310. The electrical devices listed above may be, in one example and as shown in FIG. 3, arranged in a region in front of the battery 310 (with respect to the front end 306) and proximate to the first e-axle 302, with the exception of the charge port 320.

Proximate to the second e-axle 304 and the rear end 308 of the vehicle 300, a power distribution device for the second e-axle 304, such as a PDU 326, may be positioned behind the battery 310. The PDU 326 may be included in a drive circuit 328 of the vehicle 300 and may distribute power to and from HV units, thereby providing a single location or junction for connecting HV loads. For example, the PDU 326 may control distribution of power to and from an electric motor, an inverter, and a converter of the second e-axle 304. By positioning the PDU 326 behind the battery 310, at the rear end 308 of the vehicle 300, a close positioning of the PDU 326 to the second e-axle 304 is enabled while maintaining direct coupling of the PDU 326 to the battery 310. Furthermore, reliance on lengthy routing of electrical cables is precluded.

As described above, in one example, an OBGi 330 may be connected to the PDU 326 to receive power from the battery 310 via the PDU 326. The OBGi 330, which may be similarly configured as the OBGi system 160 of FIGS. 1 and 2, may be positioned behind the PDU 326, at the rear end 308 of the vehicle 300. External auxiliary loads and electrical consumers may thereby be readily coupled, e.g., plugged in, to the OBGi 330 (such as at an outlet panel of the OBGi) by an operator. In order to electrically couple the OBGi 330 to the PDU 326, an electrical coupler 332 may be used. In one example, the electrical coupler may be a splitter header 332 allowing coupling of a source device (e.g., a device that the splitter header is plugged into) to more than one other electrical device, the more than one other electrical device including both electrical energy storage devices and energy consuming device.

The splitter header 332 may allow the PDU 326 to be electrically coupled to both the OBGi 330 and the battery 310. Furthermore, the splitter header 332 may operate as an electrical junction box that enables coupling of auxiliary loads and electrical consumers to the splitter header 332, in addition to the PDU 326, the battery 310, and the OBGi 330. An exemplary configuration of the splitter header 332 is depicted in FIGS. 4-7.

Turning now to FIG. 4, a splitter header 400 is illustrated, which may be an embodiment of the splitter header 332 of FIG. 3. A set of reference axes 401, indicating an x-axis, a y-axis, and a z-axis is provided for FIGS. 4-7. The splitter header 400 may have a first portion 402 and a second portion 404, the first portion 402 stacked above the second portion along the y-axis and the two portions intersecting at a plate 406.

The first portion 402 may include a shroud 408 surrounding sockets 410 of the splitter header 400, the sockets 410 including electrical terminals. The sockets 410 may protrude upwards along the y-axis, from the plate 406. The shroud 408 may form a continuous wall around the sockets 410 and may vary in height around the sockets 410, the height defined along the y-axis. For example, the height of the shroud 408 may remain shorter than a height of the sockets 410. The shroud 408 may however, include walls 408a aligned with the z-axis that are taller in height than portions of the shroud 408 parallel with the x-axis. A geometry of the shroud 408 may guide an orientation of a connector relative to the splitter header 400, when the connector is coupled to the sockets 410, as shown in FIG. 5 and described further below. For example, the connector may be constrained to be oriented along the z-axis due to an upwards protrusion of the walls 408a of the shroud 408.

The first portion 402 may further include a base 412, from which the sockets 410 extend. The base 412 may enclose various electrical components that provide electrical continuity between the first portion 402 and the second portion 404 of the splitter header 400 and control a voltage and current communicated between the first portion 402 and the second portion 404. In one example, the base 412 may include switches for controlling power transmission through the splitter header 400 via one or both of the sockets 410.

The second portion 404 of the splitter header 400 may include bus bars 414 extending downwards, along the y-axis, from the plate 406. The bus bars 414 may be conductors configured to be inserted into receiving ports of an electrical device, such as the PDU 326 or the SDU 324 of FIG. 3. When coupled to the electrical device, electrical energy may be transmitted between the sockets 410 and the bus bars 414. For example, the electrical device may receive power from a power source coupled to at least one of the sockets 410, deliver at least a portion of the power to another electrical device coupled to another one of the sockets 410, and/or transmit at least a portion of the power through one of the sockets 410 to a device coupled to the bus bars 414. However, the power may flow through the splitter header 400 along other directions or paths, as described further below.

The splitter header 400 is shown in FIG. 5 coupled to an HVEDS connector 500, where the HVEDS connector 500 may be a conventional HV connector. The HVEDS connector 500 may allow cables enclosed in cable sheaths 502 to transmit power from an electrical device providing power, such as a HV battery. At least a portion of the cables may be enclosed within the cable sheaths 502, thereby precluding flexing or bending of the cables therein. The cables may therefore remain fixed in orientation relative to the HVEDS connector 500 which may constrain an orientation of the HVEDS connector 500 relative to the splitter header 400.

The HVEDS connector 500 may have rigid rows of pins configured to couple to the first portion 402 of the splitter header 400. For example, a set of rows of the pins may be inserted into one of the sockets 410 of the splitter header 400. An alignment of each set of the rows, where each set of the rows may be electrically continuous with one of the cables, may be arranged parallel with the cable sheaths 502 and with the z-axis. Thus, coupling of the HVEDS connector 500 to the first portion 402 of the splitter header 400 may demand alignment of a longitudinal axis 504 of the HVEDS connector 500 with the z-axis. As shown in FIG. 5, the HVEDS connector 500 may be oriented such that the cable sheaths 502 extend away from the splitter header 400 to a right of the splitter header 400, along the z-axis. However, due to a configuration of the shroud 408 of the splitter header 400 (e.g., symmetry across a plane A-A′ of FIG. 4), the HVEDS connector 500 may also be coupled to the splitter header 400 from an opposite orientation, with the cable sheaths 502 extending away from the splitter header 400 to the left.

For example, the shroud 408 of FIG. 4 (and the splitter header 400) has the plane of symmetry A-A′, parallel with the x-y plane, as indicated in FIG. 4. The shroud 408 also has an additional plane of symmetry parallel to the z-y plane and therefore has two planes of symmetry along a common axis (e.g., the y-axis). The HVEDS connector 500 may therefore be equivalently coupled to the splitter header 400 with the HVEDS connector 500 and the cable sheaths 502 extending in either direction along the z-axis. The symmetry of the shroud 408 thereby enables bi-directional coupling of the HVEDS connector 500 to the splitter header 400, providing more flexible positioning of electrical devices coupled via the splitter header 400 compared to conventional splitter headers with asymmetric, unidirectional shrouds.

As described above, the splitter header 400 may operate as a junction box in an electrical architecture of an electrified vehicle to allow and control intersection of more than one electrical circuit for selective power transmission. As an example, the splitter header 400 may be configured to couple to an electrical circuit of a power distribution device, such as PDU or SDU, at the bus bars 414 of the second portion 404. At the first portion 402 of the splitter header 400, more than one electrical device may be electrically coupled to the sockets 410. For example, one or more of sockets may be electrically coupled to a circuit of an HV battery and one or more of the sockets 410 may be electrically coupled to a circuit of an OBGi. Transmission of power to the electrical device may therefore be controlled by the switches implemented in the base 412 of the splitter header 400. For example, power from the battery may be received at the first portion 402 of the splitter header 400 and transmitted to both the second portion 404 of the splitter header 400 to deliver power to the PDU or SDU and the one or more sockets 410 of the first portion 402 to which the OBGi is electrically coupled to also supply power to the OBGi.

As another example, the first portion 402 of the splitter header 400 may be electrically coupled to each of the HV battery and a secondary battery while the second portion 404 is coupled to the PDU or SDU. Power may be transmitted from either the HV battery or the secondary battery to the PDU/SDU, transmitted from the HV battery to one or more of the PDU/SDU and the secondary battery, or transmitted from the secondary battery to one or more of the PDU/SDU and the HV battery. In yet another example, the PDU/SDU may deliver power to one or more of the HV battery and the secondary battery when a corresponding e-axle is operating in a regenerative mode.

As such, the splitter header 400 may provide versatile electrical coupling of electric devices in the electrified vehicle. Although a one-in-two-out configuration of the splitter header 400 is described herein, it will be appreciated that configurations including more complex combinations, e.g., more than one-in and more than two-out, have been contemplated. The splitter header 400 may thereby be a junction box that enhances a configurational flexibility of the electrical architecture, allowing target electrical devices, such as the OBGi, to be positioned in a more useful and accessible region of the electrified vehicle while enabling additional electrical devices to be in electrical communication. The electrified vehicle may therefore operate as a power station in addition to a means of transport. A first example of an electrical configuration 600 of the splitter header 400 is represented in FIG. 6 as a block diagram. As described above, the splitter header 400 may be configured to couple an electrical circuit to at least one other electrical circuit and thereby provide electrical continuity between the electrical circuits. A first set of cables 602, corresponding to a first electrical circuit, and a second set of cables 604, corresponding to a second electrical circuit are shown extending from opposite sides of the splitter header 400. Each of the first and second sets of cables 602, 604 may be connected to at least one of the sockets 410 of the splitter header 400. In other words, the first and second sets of cables 602, 604 are electrical cables of separate, independent electrical devices. An electrical circuit of the electrical configuration 600 may therefore have three branches: a first branch formed of the first set of cables 602, a second branch formed of the second set of cables 604, and the bus bars 414. Power may flow in through one or two of the branches and flow out through one or two of the branches. The first set of cables 602 may be input to and output from a right side of the splitter header 400 and the second set of cables 604 may be input to and output from a left side of the splitter header 400. It will be appreciated that an orientation of the sets of cables shown in FIGS. 6 and 7 is non-limiting and the orientation may be reverse, in other examples, or may be arranged in a perpendicular configuration, as another example, relative to the splitter header 400.

A first set of electrical connections or terminals 606, representing terminals of one of the sockets 410 of the splitter header 400, and a second set of electrical connections or terminals 608, representing terminals of the other of the sockets 410, are represented as rectangular outlines in FIG. 6. As an example, the first set of cables 602 may be electrically coupled to the first set of terminals 606 of the splitter header 400, allowing the first electrical circuit to be selectively electrically continuous with an electrical circuit of an electrical device into which the splitter header 400 is plugged (e.g., at the bus bars 414 of the splitter header 400). Electrical continuity between the circuits may be controlled by the switches incorporated into the base 412 of the splitter header 400, as described above.

In the example of FIG. 6, the electrical configuration of the splitter header 400 may demand use of cables of a common wire gauge. For example, as the electrical circuits may be selectively coupled to one another, the sets of cables may flow a common amperage and may therefore be configured to have similar electrical properties in order to mitigate overcurrent and overload issues as well as excessive heat generation leading to degradation of the cables, the splitter header 400, and other nearby components. However, in some examples, electrical coupling of electrical devices relying on different current flows may be desired. In order to address this issue, fuses may be incorporated into the splitter header 400, as illustrated in FIG. 7.

Turning to FIG. 7, a second example of an electrical configuration 700 of the splitter header 400 is shown. The splitter header 400 may be adapted with fuses to enable coupling of electrical circuits utilizing cables with different wire gauges. The electrical configuration 700 is also depicted as a block diagram in FIG. 7 and includes components previously shown and described with respect to FIG. 6. A first fuse 702 may be arranged in a first electrical circuit that includes the first set of terminals 606 and a first set of cables 704. For example, the first fuse 702 may bridge the terminals of the first set of terminals 606. Similar, a second fuse 706 may be arranged in a second electrical circuit that includes the second set of terminals 608 and a second set of cables 708 where the second fuse 706 bridges the terminals of the second set of terminals 608.

As shown in FIG. 7, the first set of cables 704 and the second set of cables 708 may have different wire gauges, and therefore may be rated to different amperages. The first fuse 702 may therefore have a current rating corresponding to an amperage of the first set of cables 704 and the second fuse 706 may have a current rating corresponding to an amperage of the second set of cables 708. The fuses may be any of a variety of fuse types, such as cartridge fuses (as shown in FIG. 7), plug fuses, single-use fuses, resettable fuses, HV fuses, etc. By implementing the fuses into the splitter header 400, where the fuses have different current ratings, electrical devices with cables of different wire gauges, and therefore amperage, may be connected to the splitter header 400 concurrently.

The fuses may mitigate overcurrent, overload, and overheating of the cables by interrupting electrical continuity through the respective electrical circuits when a current flows therethrough that is higher than the current ratings of the fuses. The fuses may be chosen such that a current carrying capacity of the fuses overlaps by a range that allows coupling of the electrical circuits within a specific current range that circumvents overloading of any of the electrical circuits. In this way, electrical devices with varying electrical operating parameters, e.g., current flow, may be electrically coupled by the splitter header 400 without causing degradation to the electrical device and components of the electrified vehicle. By incorporating the fuses, downstream wire gauges may be optimized for sizing, which may reduce weight, costs, and enable more efficient packaging. Furthermore, overloading of downstream devices may be mitigated.

In addition to providing bi-directional coupling, a splitter header, e.g., the splitter header 400 of FIG. 4-7, may allow electrical coupling of an OBGi to different power sources in an electrical architecture of a vehicle. For example, an OBGi may be coupled, via a respective splitter header, to one or more of a PDU (such as the PDU 326 of FIG. 3) at a rear e-axle of the vehicle, a SDU (such as the SDU 324 of FIG. 3) at a front e-axle of the vehicle, and a HV battery (such as the battery 310 of FIG. 3) of the vehicle. In other words, an OBGi may be coupled to one of the PDU, the SDU, or the HV battery, to more than one of the PDU, the SDU, and the HV battery, or an OBGi may be coupled to each of the PDU, the SDU, and the HV battery. In addition, the splitter header may provide further flexibility with respect to power transmission to OBGis by powering devices in a trailing system hauled by the vehicle, as one example. Different use-cases are shown in FIGS. 8-12 for applying the splitter header to electrical devices of the vehicle for power distribution to the OBGi. The use-cases may be applied, in some examples, to a vehicle assembly where an electrified vehicle may be towing a load, such as a trailer, that may or may not include an e-axle and/or an energy storage device.

In an example of a first use-case for a splitter header, a tractor-trailer 800 is shown in FIG. 8, the tractor-trailer 800 including a truck 802 and a trailer 804. The truck 802 includes one or more e-axles but does not include a battery. Instead, a battery is included in the trailer 804, as well as at least one e-axle. For example, the battery may be positioned in an underbody of the trailer 804, between wheels of the trailer 804. An electrical flow diagram 820 is illustrated below the tractor-trailer 800 in FIG. 8, indicating transmission of power with arrows representing electrical cables. Components enclosed in box 806 correspond to the truck 802 and components enclosed in box 808 correspond to the trailer 804.

As shown in box 806 of the electrical flow diagram 820, the truck 802 may have a first splitter header 822 coupled to e-axles 824 of the truck 802. For example, the first splitter header may be connected to a PDU of the e-axles 824, as shown in FIG. 3. Power may be supplied to the first splitter header 822 to energize electrical consumers 826, such as auxiliary loads and/or an HVAC system of the truck 802, from a battery 828 of the trailer 804, as shown in box 808. The electrical consumers 826 may be coupled to the first splitter header 822 by an OBGi, in one example, or by another type of electrical interfacing device, in other examples. Cables transmitting power may deliver power to the PDU of the e-axles 824 by coupling of the cables at one end to the first splitter header 822 and, at an opposite end, to a second splitter header 830 that is plugged into the battery 828.

Power may therefore be supplied to the electrical consumer 826 from the battery 828. Battery power may also be distributed to a PDU of an e-axle 832 of the trailer 804. Cables for transmitting power from the battery 828 to the e-axle 832 may be coupled at one end to the second splitter header 830 and at an opposite end to a third splitter header 834 that is plugged into the PDU of the e-axle 832. In some examples, a direction of power flow may be reversed, supplying power to the battery 828 from the e-axles 824 of the truck 802 during, for example braking operations where electric motors of the e-axles 824 may operate as generators. Similarly, power maybe transmitted from the e-axle 832 of the trailer 804 during braking operators at the trailer 804. The third splitter header 834 may further be coupled via an OBGi or some other interfacing device, to electrical consumers 836, which may include customer electrical loads, such as refrigeration systems, etc. Battery power may therefore be delivered to various electrical consumers by way of power distribution devices at e-axles of the tractor-trailer 800 by coupling the splitter headers to the battery and the power distribution devices.

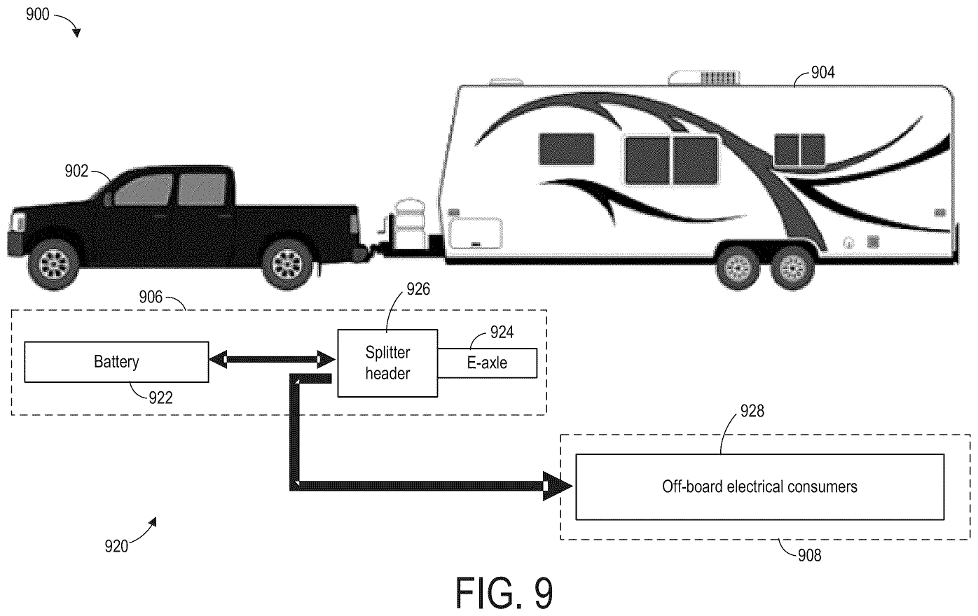

An example of a second use-case for a splitter header is depicted in FIG. 9. The second use-case may rely on at least one splitter header in a trailer assembly 900, including a truck 902 (e.g., a passenger truck), and a travel trailer 904. The travel trailer 904 may be coupled to and hauled by the truck 902, where the truck 902 is configured with a battery and at least one e-axle. The travel trailer 904 does not include a battery or an e-axle but may have an OBGi, or some other type of interfacing device, for coupling electrical consumers thereto.

An electrical flow diagram 920 for the trailer assembly 900 is shown below the trailer assembly 900 in FIG. 9. Electrical devices and components corresponding to the truck 902 are indicated in box 906 and electrical devices and components corresponding to the travel trailer 904 are indicated in box 908. The electrical devices and components may be electrically coupled by cables represented as arrows. The truck 902 may include a battery 922 electrically coupled to an e-axle 924 of the truck 902 by a splitter header 926, which may be plugged into the e-axle 924. As described above, in some instances the battery may receive power from the e-axle 924 during braking operations with an electric motor of the e-axle 824 operating as a generator.

The e-axle 924 may be further coupled to off-board/external electrical consumers 928 of the travel trailer 904 by the splitter header 926, e.g., by cables extending between the splitter header 926 and the OBGi or some other type of interfacing device. The electrical consumers 928 may include, in one example, off-board/external loads, such as a refrigerator, appliances, a winch, etc. In another example, the electrical consumers 928 may be an off-board range extending battery, further coupled to auxiliary customer loads. For example, the off-board range extending battery may be charged by the battery 922 of the truck 902. By coupling the splitter header 926 to the e-axle 924 of the truck 902, the truck's battery 922 may power the off-board electrical consumers 928 of the travel trailer 904.

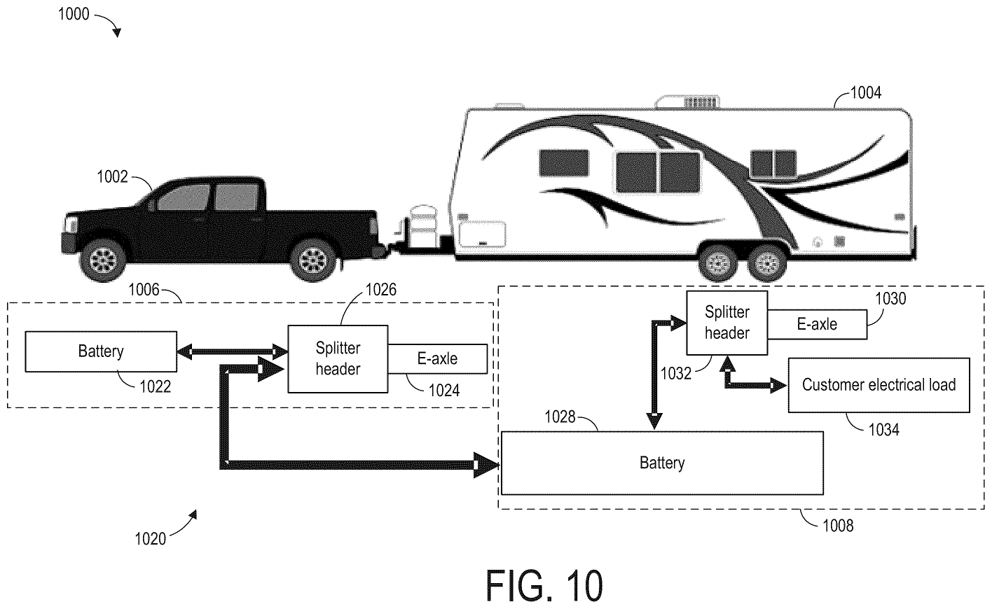

An example of a third use-case for a splitter header is shown in FIG. 10. The third use-case may use one or more splitter headers in a trailer assembly 1000, which includes a truck 1002 (e.g., a passenger truck), and a travel trailer 1004. The travel trailer 1004 maybe coupled to and hauled by the truck 1002. The truck 1002 may have a battery and at least one e-axle while the travel trailer 1004 may also include a battery and at least one e-axle.

An electrical flow diagram 1020 is illustrated below the trailer assembly 1000 in FIG. 10. Electrical devices and components corresponding to the truck 1002 are enclosed by box 1006 and electrical devices and components corresponding to the travel trailer 1004 are enclosed by box 1008. The electrical devices and components may be electrically coupled by cables represented as arrows. As shown in box 1006, the truck 1002 has a first battery 1022 which may be coupled to a first e-axle 1024 of the truck 1002 by a first splitter header 1026. The first splitter header 1026 may be plugged into a PDU of the first e-axle 1024, for example. Power may thereby be sent from the first battery 1022 to the first e-axle 1024 or, during operation of an electric motor of the first e-axle 1024 in a generator mode, power may be supplied to the battery for charging from the first e-axle 1024. The PDU of the first e-axle 1024 may be further electrically coupled to a second battery 1028 of the travel trailer 1004, as shown in box 1008, via the first splitter header 1026.

As such, the travel trailer 1004 may be a battery-powered trailer, with the second battery 1028 drawing power from the PDU of the first e-axle 1024 of the truck 1002. Alternatively, the second battery 1028 may deliver power to the first e-axle 1024 of the truck 1002. For example, the first e-axle 1024 may be powered by the first battery 1022 or the second battery 1028 depending on which has a higher state-of-charge or is coupled to fewer or less power consuming loads.

The second battery 1028 may also deliver power to a second e-axle 1030 of the travel trailer 1004 via a second splitter header 1032 plugged into a PDU of the second e-axle 1030 of the travel trailer 1004. In some instances, the second e-axle 1030 may supply power to the second battery 1028, such as during operations that result in power generation at the second e-axle 1030. The second e-axle 1030 may further distribute power, through the second splitter header 1032, to one or more customer electrical loads 1034, including auxiliary loads such as refrigerators, appliances, etc. In some examples, the PDU of the second e-axle 1030 may be connected to an OBGi or some other interfacing device to receive power from the second e-axle 1030. In yet other examples, the customer electrical loads may include an energy source which may be used to transmit power to the second e-axle 1030 which, in turn, may replenish charge at the second battery 1028.

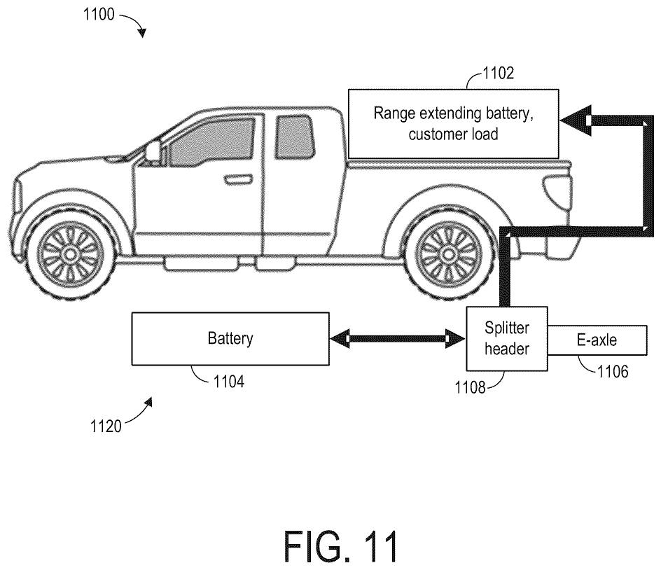

As shown in FIG. 11 in an example of a fourth use-case for a splitter header, the splitter header may enable charging of a secondary battery 1102, such as a range extending battery arranged in a bed of a truck 1100 and transported by the truck 1100. An electrical flow diagram 1120, overlaid with the truck 1100, indicates that the truck 1100 has a main battery 1104 and at least one e-axle 1106. As described above, the battery may be coupled to the e-axle 1106 by the splitter header 1108 (e.g., by electrical cables extending therebetween), which may be plugged into a PDU of the e-axle 1106. The e-axle 1106 may receive power from the main battery 1104 and distribute at least a portion of the power, upon demand, to the secondary battery 1102. Alternatively, the e-axle 1106 may deliver power to the main battery 1104 for charging when power is generated at the e-axle 1106.

The use-cases shown in FIGS. 8-11 demonstrate a capability of a splitter header, as depicted in FIGS. 4-7, to expand power distribution configurations for a vehicle, and in particular, a vehicle with a load such as a trailer. By adapting at least one power device with the splitter header, electrical coupling of the power device with more than one other device is enabled. Energy storage devices, such as a HV battery, may deliver power to the other components via connections utilizing the splitter header and also receive power from one or more power sources coupled via the splitter header. The bi-directional connectivity of the splitter header may provide more flexibility for orientation of electrical connectors with the splitter header, thereby increasing options for arranging electrical connections to accommodate tight packaging space. By orienting the electrical connections as demanded based on available space, power may be efficiently distributed and transferred between power devices, including electrical consumers external to the vehicle.

Furthermore, the splitter header may be used to provide power to the external electrical consumers from power devices proximate to ends of the vehicle rather than directly from a HV bus of the HV battery, which may be arranged in a central region in an underbody of the vehicle. For example, the splitter header may be coupled to a PDU or an SDU distributing power to e-axles of the vehicle. As such, an OBGi may be positioned at a rear end or a front end of the vehicle and connected to the PDU or the SDU via the splitter header. Routing of electrical cables between the OBGi and the PDU or SDU is reduced compared to when the OBGi relies on power supply directly from the HV battery. In addition, the splitter header may be readily adapted to existing vehicle electrical architectures, enabling simplification of electrical routing and more efficient positioning of electrical devices.

A method 1200 for using a splitter header in an electrical architecture of a vehicle is shown in FIG. 12. The vehicle may have at least two e-axles, including a first e-axle at a front end of the vehicle that is powered by a SDU and a second e-axle at a rear end of the vehicle that is powered by a PDU. In one example, the vehicle has the electrical architecture of the vehicle 300 of FIG. 3 and the splitter header is the splitter header 400 of FIGS. 4-5, which may or may not include fuses disposed therein. The method may be executed by, as one example, an operator of the vehicle, or, as another example, by an automated system used during assembly of the vehicle power system. For example, the vehicle may be a newly manufactured vehicle at a production site or a vehicle with an already existing electrical architecture to which the splitter header may be added as an aftermarket product. The method may also be at least partially executed by a VSC, such as the SC 148 of FIG. 1, based on instruction stored on a memory of the VSC and in conjunction with sensors of the vehicle. For example, the sensors may include a sensor monitoring a battery state-of-charge, voltmeters for measuring voltage, temperature sensors for monitoring heat generation at components of the electrical architecture, etc. Operation of the components, and associated power transmission, may be adjusted according to information from the sensors.

At 1202, the method includes coupling the splitter header to a power distribution device. The power distribution device may be, for example, the PDU, the SDU, and/or an HV bus of a battery. The splitter header may be coupled to the power distribution device by inserting bus bars of the splitter header, e.g., the bus bars 414 of FIGS. 4-5, into a receiving port of the power distribution device. An inner electrical configuration of the splitter header may thereby be electrically coupled to an electric circuit of the power distribution device.

At 1204, the method includes connecting an OBGi to the splitter header. For example, after the splitter header is coupled to the power distribution device, an HVEDS connector of the OBGi may be coupled to at least one socket of the OBGi, such as one of the sockets 410 of FIG. 4. Further, at 1206, a power source, such as a battery, may be connected to at least one other socket of the splitter header. It will be appreciated that in some examples, 1206 may be performed after 1208 instead or 1206 and 1208 may be performed concurrently. As such, the splitter header may enable intersection of independent electrical circuits.

At 1208, the method includes connecting one or more external electrical consumers to the OBGi. For example, the external electrical consumers may be devices that are not included as a component of the vehicle but demand power from the battery. The external electrical consumers may include a winch, a refrigeration system, an electro-hydraulic system, towing technology facilitators, an appliance, amongst others. In another example, the external electrical consumer may be a power device able to deliver energy to the battery. For example, the external electrical consumer may be a secondary or auxiliary battery that may draw energy from the HV battery of the vehicle when being charged and may alternatively supply energy to the HV battery of the vehicle upon demand, such as when the HV battery charge is low and the vehicle is not operating in a mode conducive to regeneration.

At 1210, the method includes operating the external electrical consumers that are connected to the OBGi. For example, at least one of the external electrical consumers may be electrically activated. As the external electrical consumer is operating, power distribution amongst other energy-consuming devices and operations may be adjusted or at least monitored. As one example, if the vehicle is already in motion, e.g., power is provided to the e-axles to enable propulsion, when the external electrical consumer is activated, power supply to the e-axles may be reduced, provided a power demand at the e-axles is met, to accommodate operation of the external electrical consumer. If the vehicle is a hybrid vehicle, reliance on engine power may be increased, in one example.

As another example, if a secondary battery is available and the state-of-charge of the HV battery is low, the secondary battery may be used to power the external electrical consumer or to charge the HV battery. In yet another example, the vehicle may be stationary and/or in a stand-by mode when the external electrical consumer is activated. If vehicle start and propulsion is initiated during operation of the external electrical consumer, power distribution may be adjusted to prioritize vehicle propulsion. For example, power transmitted to the OBGi may be reduced or power may instead be supplied to the OBGi from the secondary battery, if present. Various adjustments to power distribution are therefore possible and enabled by flexible coupling of the components of the electrical architecture of the vehicle via the splitter header.

Furthermore, vehicle operations may be adjusted based on whether an external electrical consumer is a dumb load or a smart load. For example, an electrical consumer configured as a dumb load may be a refrigeration system that merely draws power from the power source. Operation of the vehicle and/or other electrical consumers may operate independent of powering of the refrigeration system. For an electrical consumer configured as a smart load, such as a power take-off, however, feedback from the electrical consumer via a module, e.g., a software module configured with algorithms for adjusting operation of the electrical consumer, may be demanded. The feedback may be used to coordinate suitable vehicle operation with operation of the electrical consumer. As an example, the electrical consumer may be an electric winch and operation of the electric winch may demand disabling of vehicle drive operations.

The software module may include capabilities and instructions for vehicle network messaging. For example, vehicle-to-vehicle charging may be enabled where the splitter header may be used as an exportable power device. Network messaging provided throughout the vehicle may allow vehicle movement to be inhibited while power is transferred from a HV battery of a charged vehicle to a HV battery bus of a discharged vehicle through the splitter header. In order to be delivered to the discharged vehicle, the power may be transmitted offboard through an electrical connection.

In this way, an electrical architecture of an electrified vehicle may be configured to provide access to an OBGi more readily while accommodating space constraints in an underbody of the electrified vehicle. The OBGi may be coupled to an e-axle, e.g., to a PDU or SDU, of the vehicle, allowing the OBGi to be positioned at regions of the vehicle that reduces a distance between electrical consumers to be connected to the OBGi and the OBGi. Power may be conducted more efficiently to the OBGi by electrically coupling the OBGi and an energy storage device of the vehicle, such as a battery, to the e-axle using a bi-directional splitter header. A symmetric shroud of the bi-directional splitter enables electrical connectors to be coupled to the bi-directional splitter header via more than one orientation while an electrical configuration of the bi-directional splitter header allows multiple electrical circuits to intersect and transmit power in a selective and controlled manner. Use of the splitter header may also introduce greater flexibility in how electrical devices are electrically coupled within the electrical architecture of the vehicle, thereby increasing an energy efficiency of the vehicle and allowing the vehicle to operate as a portable power station while maintaining high vehicle performance.

FIGS. 4-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 4-7 are shown approximately to scale.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The disclosure also provides support for an electrified vehicle, comprising: at least one electric transaxle having a power distribution device, a battery supplying power to the power distribution device, and an electrical interfacing device electrically coupled to the power distribution device and positioned proximate to the at least one electric transaxle, the electrical interfacing device configured to deliver power to electrical consumers external to the electrified vehicle. In a first example of the system, the at least one electric transaxle is located proximate to a rear end of the electrified vehicle and the power distribution device is a power distribution unit (PDU) coupled to the at least one electric transaxle. In a second example of the system, optionally including the first example, the electrical interfacing device is positioned behind the PDU, with respect to the rear end of the electrified vehicle, and wherein the PDU is located between the battery and the electrical interfacing device. In a third example of the system, optionally including one or both of the first and second examples, the battery is electrically coupled to the power distribution device using a bi-directional splitter header configured to operate as an electrical junction box. In a fourth example of the system, optionally including one or more or each of the first through third examples, the electrical interfacing device is electrically coupled to the battery by the bi-directional splitter header, and wherein the electrical interfacing device and the power distribution device are configured to both receive power from the battery through the bi-directional splitter header. In a fifth example of the system, optionally including one or more or each of the first through fourth examples, the power distribution device is a secondary drive unit (SDU) of an all-wheel drive circuit of the electrified vehicle. In a sixth example of the system, optionally including one or more or each of the first through fifth examples, the electrical interfacing device is an onboard generator inverter (OBGi), and the electrical consumers include one or more of a refrigeration system, a winch, an electro-hydraulic system, an appliance, an energy storage device, and towing technology facilitators. In a seventh example of the system, optionally including one or more or each of the first through sixth examples, one of the electrical consumers is an auxiliary battery, and wherein the auxiliary battery is configured to consume power from or deliver power to one or more of the battery and the power distribution device.

The disclosure also provides support for a method for a vehicle assembly, comprising: coupling one or more electrical consumers to a first electric transaxle of the vehicle assembly using a first splitter header, the one or more electrical consumers arranged external to the vehicle assembly, and operating the one or more electrical consumers by supplying power from a first battery of the vehicle assembly to the one or more electrical consumers through the first electric transaxle. In a first example of the method, the first splitter header is configured to connect to the first electric transaxle at a power distribution device of the first electric transaxle, and wherein the one or more electrical consumers and the first battery are each coupled to the first splitter header. In a second example of the method, optionally including the first example, a second splitter header is connected to a power distribution device of a second electric transaxle of the vehicle assembly, and wherein the first electric transaxle and the second electric transaxle are electrically coupled to the first battery by a third splitter header connected to the first battery. In a third example of the method, optionally including one or both of the first and second examples, the first electric transaxle and the first battery are located at a trailer of the vehicle assembly and a second splitter header is connected to a second electric transaxle of the vehicle assembly, the second electric transaxle located at a truck of the vehicle assembly, and wherein the second electric transaxle is electrically coupled to both a second battery of the truck and the first battery by the second splitter header. In a fourth example of the method, optionally including one or more or each of the first through third examples, the one or more electrical consumers is a second battery transported by a truck of the vehicle assembly and wherein the second battery is electrically coupled to the first battery by the first splitter header. In a fifth example of the method, optionally including one or more or each of the first through fourth examples, the first splitter header is configured to receive electrical connectors according to more than one orientation of the electrical connectors relative to the first splitter header.

The disclosure also provides support for an electrical coupler for a vehicle, comprising: a first portion configured to connect to an electric transaxle of the vehicle, a second portion coupled to the first portion by a plate and extending away from the plate in an opposite direction from the first portion, the second portion configured to electrically couple to more than one electrical circuit, and a shroud surrounding the second portion and having two planes of symmetry along a common axis. In a first example of the system, the first portion is connected to the electric transaxle by bus bars configured to be inserted into a receiving port at the electric transaxle. In a second example of the system, optionally including the first example, the shroud has a first set of parallel walls that are taller than a second set of parallel walls, the second set of parallel walls perpendicular to the first set of parallel walls. In a third example of the system, optionally including one or both of the first and second examples, the shroud enables one or more connectors to be coupled to the second portion of the electrical coupler from more than one direction relative to the electrical coupler. In a fourth example of the system, optionally including one or more or each of the first through third examples, the second portion has at least two sockets protruding from the plate, and wherein each of the at least two sockets is configured to couple to an electrical circuit of an electrical device. In a fifth example of the system, optionally including one or more or each of the first through fourth examples, the second portion of the electrical coupler is adapted with one or more fuses, each of the one or more fuses selected according to a cable wire gauge of an electrical device coupled to the second portion.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electrified vehicle, comprising:
at least one electric transaxle having a power distribution device;
a battery supplying power to the power distribution device; and
an electrical interfacing device electrically coupled to the power distribution device and positioned proximate to the at least one electric transaxle, the electrical interfacing device configured to deliver power to electrical consumers external to the electrified vehicle.

2. The electrified vehicle of claim 1, wherein the at least one electric transaxle is located proximate to a rear end of the electrified vehicle and the power distribution device is a power distribution unit (PDU) coupled to the at least one electric transaxle.

3. The electrified vehicle of claim 2, wherein the electrical interfacing device is positioned behind the PDU, with respect to the rear end of the electrified vehicle, and wherein the PDU is located between the battery and the electrical interfacing device.

4. The electrified vehicle of claim 1, wherein the battery is electrically coupled to the power distribution device using a bi-directional splitter header configured to operate as an electrical junction box.

5. The electrified vehicle of claim 4, wherein the electrical interfacing device is electrically coupled to the battery by the bi-directional splitter header, and wherein the electrical interfacing device and the power distribution device are configured to both receive power from the battery through the bi-directional splitter header.

6. The electrified vehicle of claim 1, wherein the power distribution device is a secondary drive unit (SDU) of an all-wheel drive circuit of the electrified vehicle.

7. The electrified vehicle of claim 1, wherein the electrical interfacing device is an onboard generator inverter (OBGi), and the electrical consumers include one or more of a refrigeration system, a winch, an electro-hydraulic system, an appliance, an energy storage device, and towing technology facilitators.

8. The electrified vehicle of claim 1, wherein one of the electrical consumers is an auxiliary battery, and wherein the auxiliary battery is configured to consume power from or deliver power to one or more of the battery and the power distribution device.

9. A method for a vehicle assembly, comprising:
coupling one or more electrical consumers to a first electric transaxle of the vehicle assembly using a first splitter header, the one or more electrical consumers arranged external to the vehicle assembly; and
operating the one or more electrical consumers by supplying power from a first battery of the vehicle assembly to the one or more electrical consumers through the first electric transaxle.

10. The method of claim 9, wherein the first splitter header is configured to connect to the first electric transaxle at a power distribution device of the first electric transaxle, and wherein the one or more electrical consumers and the first battery are each coupled to the first splitter header.

11. The method of claim 9, wherein a second splitter header is connected to a power distribution device of a second electric transaxle of the vehicle assembly, and wherein the first electric transaxle and the second electric transaxle are electrically coupled to the first battery by a third splitter header connected to the first battery.

12. The method of claim 9, wherein the first electric transaxle and the first battery are located at a trailer of the vehicle assembly and a second splitter header is connected to a second electric transaxle of the vehicle assembly, the second electric transaxle located at a truck of the vehicle assembly, and wherein the second electric transaxle is electrically coupled to both a second battery of the truck and the first battery by the second splitter header.

13. The method of claim 9, wherein the one or more electrical consumers is a second battery transported by a truck of the vehicle assembly and wherein the second battery is electrically coupled to the first battery by the first splitter header.

14. The method of claim 9, wherein the first splitter header is configured to receive electrical connectors according to more than one orientation of the electrical connectors relative to the first splitter header.

15. An electrical coupler for a vehicle, comprising:
a first portion configured to connect to an electric transaxle of the vehicle;
a second portion coupled to the first portion by a plate and extending away from the plate in an opposite direction from the first portion, the second portion configured to electrically couple to more than one electrical circuit; and
a shroud surrounding the second portion and having two planes of symmetry along a common axis.

16. The electrical coupler of claim 15, wherein the first portion is connected to the electric transaxle by bus bars configured to be inserted into a receiving port at the electric transaxle.

17. The electrical coupler of claim 15, wherein the shroud has a first set of parallel walls that are taller than a second set of parallel walls, the second set of parallel walls perpendicular to the first set of parallel walls.

18. The electrical coupler of claim 15, wherein the shroud enables one or more connectors to be coupled to the second portion of the electrical coupler from more than one direction relative to the electrical coupler.

19. The electrical coupler of claim 15, wherein the second portion has at least two sockets protruding from the plate, and wherein each of the at least two sockets is configured to couple to an electrical circuit of an electrical device.

20. The electrical coupler of claim 15, wherein the second portion of the electrical coupler is adapted with one or more fuses, each of the one or more fuses selected according to a cable wire gauge of an electrical device coupled to the second portion.
